(19) United States
(12) Patent Application Publication
(10) Pub. No.: US 2012/0302431 A1
(43) Pub. Date: Nov. 29, 2012

(54) COMPOSITE CATALYST AND METHOD FOR PREPARATION THEREOF

(76) Inventors: Huaming YANG, Changsha (CN); Xi HE, Changsha (CN); Jing OUYANG, Changsha (CN); Aidong TANG, Changsha (CN)

(21) Appl. No.: 13/335,916

(22) Filed: Dec. 22, 2011

(30) Foreign Application Priority Data
May 26, 2011 (CN) 201110139082.4

(51) Int. Cl. B01J 21/16; B01J 31/02; B82Y 30/00

(52) U.S. Cl. 502/62; 502/84; 502/81; 977/840

(57) ABSTRACT

A composite catalyst, including: a) dispersed and cationic surface modifier-modified attapulgite as a catalyst carrier; and b) nano-Au as an active ingredient. The nano-Au accounts for 0.5-1.5 wt. % of the attapulgite. An average diameter of the attapulgite is 18-22 nm, and a length thereof is 100-1000 nm. A particle diameter of the nano-Au is 1-7 nm. The composite catalyst has a low activation temperature and high performance-to-price ratio, and can be used for oxidation of organic pollutants in waste gas under low temperatures and also has excellent catalytic effects on organic pollutants in waste fluid. A preparation method of the composite catalyst is also provided.

### CROSS-REFERENCE TO RELATED APPLICATIONS

Pursuant to 35 U.S.C. §119 and the Paris Convention Treaty, this application claims the benefit of Chinese Patent Application No. 201110139082.4 filed May 26, 2011, the contents of which are incorporated herein by reference.

### BACKGROUND OF THE INVENTION

1. Field of the Invention

The invention relates to the categories of pollution control technology and environmental catalytic materials, and more particularly to a composite catalyst for oxidation removal of organic pollutants in waste gas and waste fluid as well as a preparation method thereof.

2. Description of the Related Art

Conventional catalysts used for degradation of organic pollutants in waste gas belong to the V₂O₅/TiO₂ system, mainly using vanadium pentoxide as an active ingredient. However, such catalysts have a restricted application because on the one hand the activation temperature of such catalysts is 200-500° C. and the catalysts almost show no activity under low temperature (i.e. within 100° C.), and on the other hand it is extremely difficult to prepare the evenly distributed V₂O₅ particles. Moreover, V₂O₅, as an active ingredient, is highly poisonous and harmful to the environment. Furthermore, the V₂O₅/TiO₂ system using vanadium pentoxide as the active ingredient cannot be used for waste fluid treatment. For waste fluid treatment, a system using TiO₂ as the active ingredient is generally used to degrade organic pollutants therein. However, the system is complicated in preparation processes and high in production costs. Thus, it is urgent to develop a new type of catalyst with a low activation temperature, simple preparation processes, and high performance-to-price ratio.

### SUMMARY OF THE INVENTION

In view of the above-described problems, it is one objective of the invention to provide a composite catalyst with a low activation temperature and high performance-to-price ratio. The composite catalyst can be used for oxidation of organic pollutants in waste gas under low temperatures and also has excellent catalytic effects on organic pollutants in waste fluid.

Another objective of the invention is to provide a preparation method for the composite catalyst.

To achieve the above objective, in accordance with one embodiment of the invention, there is provided a composite catalyst for oxidation of organic pollutants in waste gas and waste fluid under low temperatures, the composite catalyst comprising dispersed and cationic surface modifier-modified attapulgite as a catalyst carrier and nano-Au as an active ingredient, wherein the nano-Au accounts for 0.5-1.5 wt. % of the attapulgite, an average diameter of the attapulgite is 18-22 nm, a length of the attapulgite is 100-1000 nm, and a particle diameter of the nano-Au is 1-7 nm.

Attapulgite is a type of clay mineral, with a chemical formula of Mg₅Si₈O₂₀(OH)₂(OH₂)₄.4H₂O, and having an intermediate structure between a chain structure and a layered structure, a rich porous structure, and a large specific surface area. The attapulgite is cheap and has extremely high adsorbability and the nano-Au has high catalytic performance. Therefore, in this invention, the attapulgite and nano-Au are synthesized into a material with extremely high catalytic performance under low temperatures.

Furthermore, an advantage of the invention is that the T₅₀ temperature (T₅₀ refers to a catalytic reaction temperature when the degradation rate of organic pollutants reaches 50%) of the composite catalyst to the organic pollutants in waste gas is 100° C. lower than that of the conventional catalysts. In other words, the composite catalyst provided by the invention still has catalytic activities within 100° C.

The removal rate of organic pollutants in waste gas may reach 99% under room temperature after the composite catalyst is stored under cold temperature for a period of time.

In another aspect, the invention provides a method for preparing a composite catalyst, the method comprising:
Dispersing and modifying the surface of an attapulgite with a cationic surface modifier;
Immersing the attapulgite in a precursor solution of aurum with a pH value of 9-11 and stirring magnetically for 50-70 mins under a constant temperature of 55-65° C.; and
Collecting an obtained product, washing with deionized water, drying under a temperature of 70-90° C., baking under a temperature of 280-320° C., and grinding to obtain the composite catalyst.

In a class of this embodiment, the attapulgite is dispersed in an aqueous solution of sodium hexametaphosphate, sodium pyrophosphate, or sodium dodecyl sulfonate, particularly an aqueous solution of sodium hexametaphosphate.

In a class of this embodiment, the cationic surface modifier is selected from the group consisting of cetyltrimethylammonium bromide (CTAB), octadecyl trimethyl ammonium chloride, and dodecyltrimethylammonium chloride, particularly CTAB.

Preferably, the method for preparing the composite catalyst comprises:
1. Preparing the precursor solution of aurum;
2. Adjusting the pH value of the precursor solution of aurum to 9-11;
3. Dispersing the attapulgite using an aqueous solution of sodium hexametaphosphate, sodium pyrophosphate, or sodium dodecyl sulfate and modifying the attapulgite using CTAB, octadecyl trimethyl ammonium chloride, or dodecyltrimethylammonium chloride, adding the dispersed and modified attapulgite to the precursor solution of aurum, heating the solution to 60° C., and stirring magnetically for 60 mins;
4. Filtering a mixed solution obtained from the step 3 and washing it twice with deionized water;
5. Drying a product obtained from the step 4 in an oven under a temperature of 80° C. for 12-24 hrs;
6. Baking a product obtained from the step 5 under a temperature of 300° C. for 2 hrs, the temperature being raised by 10° C./min; and
7. Grinding a product obtained from the step 6 to obtain the composite catalyst.

In a class of this embodiment, a concentration of the precursor solution of aurum is 0.5-1.5 mmol/L.

In a class of this embodiment, the precursor solution of aurum is auric chloride acid (HAuCl₄.4H₂O).

Advantages of the invention are summarized below:

1. A nano-Au supported composite catalyst using attapulgite as the carrier is obtained in the invention for the first time. The attapulgite has a rich porous structure and a large specific surface area, which is favorable for high dispersion of aurum. Moreover, the nano-Au particle is within 1-7 nm, the number of active sites is increased and catalytic efficiency of aurum is improved, therefore, it is helpful for the catalytic reaction and its efficiency is improved accordingly.

2. The composite catalyst prepared in accordance with the invention can be used for catalytic oxidation of organic pollutants under low temperatures and the T₅₀ temperature for catalytic reaction of organic pollutants is greatly reduced, therefore the catalytic reaction can be conducted under the temperature of 100° C. After the composite catalyst is stored under cold temperature for a period of time, its removal rate to organic pollutants under room temperature can still reach 99%.

3. The composite catalyst prepared in accordance with the invention can be used for catalytic oxidation of organic pollutants in waste water. It has catalytic effects on organic pollutants both in waste gas and waste fluid and it has wider applications compared with conventional catalysts.

4. The attapulgite, as one of the raw materials used in the invention, is a type of natural nano-mineral and it is cheap and easily accessible.

5. The preparation method provided by the invention is simple. The attapulgite, after dispersion and surface modification, is helpful for the achievement of high dispersion and controllable dimensions of aurum, so that the organic pollutants and the aurum in active sites can be fully contacted to improve the catalytic efficiency.

### DETAILED DESCRIPTION OF THE EMBODIMENTS

For further illustrating the invention, experiments detailing a composite catalyst and preparation method thereof are described below. It should be noted that the following examples are intended to describe and not to limit the invention.

### EXAMPLE 1

Dissolve 0.041 g of auric chloride acid in 200 mL of deionized water, maintain the obtained solution at a constant temperature of 20° C. and add 4.0 M of ammonia solution to adjust the pH value to 9, slowly add 1.307 g of attapulgite to the mixed solution after the attapulgite has been dispersed using sodium hexametaphosphate (mass ratio between the sodium hexametaphosphate and the attapulgite is 1%) and modified using CTAB (0.5 g/100 mL), heat the solution to the temperature of 60° C. and stir magnetically, and add 4.0 M of ammonia solution to adjust the pH value to 9 and maintain the constant temperature for 60 mins. Afterwards, take out the obtained product and wash it twice with the deionized water, dry in an oven under the temperature of 80° C. for 12 hrs, bake under the temperature of 300° C. for 2 hrs, and finally grind the obtained product to obtain the composite catalyst.

Catalytic conditions: total gas flow is 240 mL/min, volume content of the o-dichlorobenzene is 3%, and space velocity is 30,000 h⁻¹.

Catalytic effects: the removal rate of o-dichlorobenzene under the room temperature is 90%. Compared with the activation temperature during the catalytic degradation of the o-dichlorobenzene with conventional catalysts as described in some documents, the activation temperature is greatly reduced by using the composite catalyst provided by the invention.

### EXAMPLE 2

Dissolve 0.082 g of auric chloride acid in 200 mL of deionized water, maintain the obtained solution at a constant temperature of 20° C. and add 4.0 M of ammonia solution to adjust the pH value to 10, slowly add 3.921 g of attapulgite to the mixed solution after the attapulgite has been dispersed using sodium pyrophosphate and modified using octadecyl trimethyl ammonium chloride, heat the solution to the temperature of 60° C. and stir magnetically, and add 4.0 M of ammonia solution to adjust the pH value to 10 and maintain the constant temperature for 60 mins. Afterwards, take out the obtained product and wash it until no chloride ion detected, dry in an oven under the temperature of 80° C. for 18 hrs, bake under the temperature of 300° C. for 2 hrs, and finally grind the obtained product to obtain the composite catalyst.

Catalytic conditions: the same as Example 1.

Catalytic effects: the removal rate of o-dichlorobenzene under the room temperature is 99%.

### EXAMPLE 3

Dissolve 0.123 g of auric chloride acid in 200 mL of deionized water, maintain the obtained solution at a constant temperature of 20° C. and add 4.0 M of ammonia solution to adjust the pH value to 11, slowly add 11.763 g of attapulgite to the mixed solution after the attapulgite has been dispersed using sodium dodecyl sulfonate and modified using dodecyltrimethylammonium chloride, heat the solution to the temperature of 60° C. and stir magnetically, and add 4.0 M of ammonia solution to adjust the pH value to 11 and maintain the constant temperature for 60 mins. Afterwards, take out the obtained product and wash it until no chloride ion detected, dry in an oven under the temperature of 80° C. for 24 hrs, bake under the temperature of 300° C. for 2 hrs, and finally grind the obtained product to obtain the composite catalyst.

Catalytic conditions: the same as Example 1.

Catalytic effects: the removal rate of o-dichlorobenzene under the room temperature is 94%.

### EXAMPLE 4

Dissolve 0.041 g of auric chloride acid in 200 mL of deionized water, maintain the obtained solution at a constant temperature of 20° C. and add 4.0 M of ammonia solution to adjust the pH value to 10, slowly add 3.921 g of attapulgite to the mixed solution after the attapulgite has been dispersed using sodium hexametaphosphate and modified using CTAB, heat the solution to the temperature of 60° C. and stir magnetically, and add 4.0 M of ammonia solution to adjust the pH value to 10 and maintain the constant temperature for 60 mins. Afterwards, take out the obtained product and wash until no chloride ion detected, dry in an oven under the temperature of 80° C. for 18 hrs, bake under the temperature of 300° C. for 2 hrs, and finally grind the obtained product to obtain the composite catalyst.

Catalytic conditions: methyl orange 25 mg/L, the usage amount of the composite catalyst is 50 mg/L, the usage amount of 30% H₂O₂ is 2 mL/L, and UV irradiation at 25 W.

Catalytic effects: the removal rate of methyl orange under the room temperature is 80% within 100 mins.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A composite catalyst, comprising:
a) dispersed and cationic surface modifier-modified attapulgite as a catalyst carrier; and
b) nano-Au as an active ingredient;
wherein
the nano-Au accounts for 0.5-1.5 wt. % of the attapulgite;
an average diameter of the attapulgite is 18-22 nm, and a length thereof is 100-1000 nm; and
a particle diameter of the nano-Au is 1-7 nm.

2. The composite catalyst of claim 1, wherein the attapulgite is dispersed in an aqueous solution of sodium hexametaphosphate, sodium pyrophosphate, or sodium dodecyl sulfonate.

3. The composite catalyst of claim 2, wherein the attapulgite is dispersed in an aqueous solution of sodium hexametaphosphate.

4. The composite catalyst of claim 1, wherein the cationic surface modifier is selected from the group consisting of cetyltrimethylammonium bromide, octadecyl trimethyl ammonium chloride, and dodecyltrimethylammonium chloride.

5. The composite catalyst of claim 2, wherein the cationic surface modifier is selected from the group consisting of cetyltrimethylammonium bromide, octadecyl trimethyl ammonium chloride, and dodecyltrimethylammonium chloride.

6. A method for preparing a composite catalyst, comprising:
a) Dispersing and modifying the surface of an attapulgite with a cationic surface modifier;
b) Immersing the attapulgite in a precursor solution of aurum with a pH value of 9-11 and stirring magnetically for 50-70 mins under a constant temperature of 55-65° C.; and
c) Collecting an obtained product, washing with deionized water, drying under a temperature of 70-90° C., baking under a temperature of 280-320° C., and grinding to obtain the composite catalyst.

7. The method of claim 6, wherein the attapulgite is dispersed in an aqueous solution of sodium hexametaphosphate, sodium pyrophosphate, or sodium dodecyl sulfonate.

8. The method of claim 7, wherein the attapulgite is dispersed in an aqueous solution of sodium hexametaphosphate.

9. The method of claim 6, wherein the cationic surface modifier is selected from the group consisting of cetyltrimethylammonium bromide, octadecyl trimethyl ammonium chloride, and dodecyltrimethylammonium chloride.

10. The method of claim 6, wherein a concentration of the precursor solution of aurum is 0.5-1.5 mmol/L.

11. The method of claim 6, wherein the precursor solution of aurum is auric chloride acid.

12. The method of claim 10, wherein the precursor solution of aurum is auric chloride acid.

13. The method of claim 4, comprising:
a) Preparing the precursor solution of aurum with a concentration of 0.5-15 mmol/L;
b) Adjusting the pH value of the precursor solution of aurum to 9-11;
c) Dispersing the attapulgite using an aqueous solution of sodium hexametaphosphate, sodium pyrophosphate, or sodium dodecyl sulfate and modifying the attapulgite using CTAB, octadecyl trimethyl ammonium chloride, or dodecyltrimethylammonium chloride, adding the dispersed and modified attapulgite to the precursor solution of aurum, heating the solution to 60° C., and stirring magnetically for 60 mins;
d) Filtering a mixed solution obtained from the step c) and washing it twice with deionized water;
e) Drying a product obtained from the step d) in an oven under a temperature of 80° C. for 12-24 hrs;
f) Baking a product obtained from the step e) under a temperature of 300° C. for 2 hrs, the temperature being raised by 10° C./min; and
g) Grinding a product obtained from the step f) to obtain the composite catalyst.
